(19) United States
(12) Patent Application Publication
(10) Pub. No.: US 2024/0095505 A1
(43) Pub. Date: Mar. 21, 2024

(54) HYBRID-SPARSE NPU WITH FINE-GRAINED STRUCTURED SPARSITY

(71) Applicant: Samsung Electronics Co., Ltd., Suwon-si (KR)

(72) Inventors: Jong Hoon SHIN, San Jose, CA (US); Ardavan PEDRAM, Santa Clara, CA (US); Joseph HASSOUN, Los Gatos, CA (US)

(21) Appl. No.: 17/980,541

(22) Filed: Nov. 3, 2022

Related U.S. Application Data
(60) Provisional application No. 63/408,827, filed on Sep. 21, 2022.
(60) Provisional application No. 63/408,828, filed on Sep. 21, 2022.

(51) Int. Cl. G06N 3/063; G06N 3/08

(52) U.S. Cl. CPC G06N 3/063; G06N 3/08

(57) ABSTRACT

A neural processing unit is disclosed that supports dual-sparsity modes. A weight buffer is configured to store weight values in an arrangement selected from a structured weight sparsity arrangement or a random weight sparsity arrangement. A weight multiplexer array is configured to output one or more weight values stored in the weight buffer as first operand values based on the selected weight sparsity arrangement. An activation buffer is configured to store activation values. An activation multiplexer array includes inputs to the activation multiplexer array that are coupled to the activation buffer, and is configured to output one or more activation values stored in the activation buffer as second operand values in which each respective second operand value and a corresponding first operand value forming an operand value pair. A multiplier array is configured to output a product value for each operand value pair.

### CROSS-REFERENCE TO RELATED APPLICATION

This application claims the priority benefit under 35 U.S.C. § 119(e) of U.S. Provisional Patent Application Serial Nos. 63/408,827, filed on Sep. 21, 2022, and 63/408,828, filed Sep. 21, 2022, the disclosures of which are incorporated herein by reference in their entirety.

### TECHNICAL FIELD

The subject matter disclosed herein relates to neural network processing devices. More particularly, the subject matter disclosed herein relates to a neural processing unit that supports dual-sparsity modes.

### BACKGROUND

Deep neural networks (DNNs) may be accelerated by Neural Processing Units (NPUs). The operand sparsity associated with General Matrix Multiply (GEMM) operations in DNNs may be used to accelerate operations performed by NPUs. Fine-grained structured sparsity, especially N:M sparsity (N nonzero elements out of M weight values), may be helpful to maintain accuracy and save hardware overhead compared to random sparsity. Existing technology related to structured sparsity, however, only supports weight sparsity.

### SUMMARY

An example embodiment provides a neural processing unit that may include a weight buffer, a weight multiplexer, an activation buffer, an activation multiplexer, and a multiplier array. The weight buffer may be configured to store weight values in an arrangement selected from a group that may include a structured weight sparsity arrangement and a random weight sparsity arrangement. The weight multiplexer array may be configured to output one or more weight values stored in the weight buffer as first operand values based on the selected weight sparsity arrangement. The activation buffer may be configured to store activation values. The activation multiplexer array may include inputs to the activation multiplexer array that may be coupled to the activation buffer, and the activation multiplexer array may be configured to output one or more activation values stored in the activation buffer as second operand values in which each respective second operand value and a corresponding first operand value form an operand value pair. The multiplier array may be configured to output a product value for each operand value pair. In one embodiment, the weight multiplexer array may be further configured to select the one or more weight values in a lookahead manner, and the activation multiplexer array may be further configured to select the one or more activation values in the lookahead manner. In another embodiment, the weight multiplexer array may be further configured to select the one or more weight values in a lookaside manner, and the activation multiplexer array may be further configured to select the one or more activation values in the lookaside manner. In still another embodiment, the weight multiplexer array may be configured to select the one or more weight values in a lookahead of at least 3 timeslots and in a lookaside of one channel, and the activation multiplexer array may be configured to select the one or more activation values in a lookahead of at least 3 time slots and in a lookaside of at least two channels. In yet another embodiment, the weight multiplexer array may be further configured to select the one or more weight values in a lookaside manner, and the activation multiplexer array may be further configured to select the one or more activation values in the lookaside manner. In one embodiment, the weight values may be stored in the weight buffer in the structured weight sparsity arrangement, and the neural processing unit may further include a control unit configured to control the activation multiplexer array to select and output one or more activation values stored in the activation buffer based on the structured weight sparsity arrangement. In another embodiment, the weight values may be stored in the weight buffer in the random weight sparsity arrangement, and the neural processing unit may further include a control unit configured to control the activation multiplexer array to select and output one or more activation values stored in the activation buffer based on the random weight sparsity arrangement of the weight values. In still another embodiment, the activation values may be stored in the activation buffer in a random activation sparsity arrangement, and the control unit may be further configured to control the activation multiplexer array to select and output the one or more activation values based on the random weight sparsity arrangement and on the random activation sparsity arrangement. In yet another embodiment, the control unit may be further configured to select and output the one or more activation values based on an ANDing of an activation zero-bit mask of activation values stored in the activation buffer and a weight zero-bit mask of weight values stored in the weight buffer. In one embodiment, the weight multiplexer array may include four multiplexers, the activation multiplexer array may include four second multiplexers and the multiplier array may include four multipliers.

An example embodiment provides a neural processing unit that may include a weight buffer, a weight multiplexer, an activation buffer, an activation multiplexer and a multiplier unit. The weight buffer may include an array of weight registers in which each weight register may be configured to store a weight value that is in an arrangement selected from a group that may include a structured weight sparsity arrangement and a random weight sparsity arrangement. The weight multiplexer may be configured to select a weight register based the weight sparsity arrangement of the weight values stored in the weight buffer and output the weight value stored in the selected weight register as a first operand value. The activation buffer may include an array of activation registers in which each activation register may be configured to store an activation value. The activation multiplexer may be to select and output an activation value stored in the activation buffer as a second operand value in which the second operand value corresponds to the first operand value and forms a first operand value pair. The multiplier unit may be configured to output a first product value for the first operand value pair. In one embodiment, the weight multiplexer may be further configured to select the weight value in a lookahead manner, and the activation multiplexer may be further configured to select the activation value in the lookahead manner. In another embodiment, the weight multiplexer may be further configured to select the weight value in a lookaside manner, and the activation multiplexer may be further configured to select the activation value in the lookaside manner. In still another embodiment, the weight multiplexer may be further configured to select the weight value in a lookaside manner, and the activation multiplexer may be further configured to select the activation value in the lookaside manner. In yet another embodiment, weight values may be stored in the weight buffer in the structured weight sparsity arrangement, and the neural processing unit may further include a control unit that may be configured to control the activation multiplexer to select and output the activation value based on the structured weight sparsity arrangement. In one embodiment, weight values may be stored in the weight buffer in the random weight sparsity arrangement, and the neural processing unit may further include a control unit configured to control the activation multiplexer to select and output the activation value based on the random weight sparsity arrangement. In another embodiment, activation values may be stored in the activation buffer in a random activation sparsity arrangement, and the control unit may be further configured to control the activation multiplexer to select and output the activation value based on the random activation sparsity arrangement. In still another embodiment, the control unit may be further configured to select and output the one or more activation values based on an ANDing of an activation zero-bit mask of activation values stored in the activation buffer and a weight zero-bit mask of weight values stored in the weight buffer. In yet another embodiment, the weight multiplexer may be part of an array of weight multiplexers, the activation multiplexer may be part of an array of activation multiplexers, and the multiplier unit may be part of an array of multipliers.

### BRIEF DESCRIPTION OF THE DRAWING

In the following section, the aspects of the subject matter disclosed herein will be described with reference to exemplary embodiments illustrated in the figure, in which:

FIG. 1A depicts an example embodiment of a NPU architecture and an example embodiment of a dual-sparsity NPU architecture according to the subject matter disclosed herein;

FIG. 1B depicts the example embodiment of a NPU architecture and an example embodiment of a dual-sparsity NPU architecture according to the subject matter disclosed herein;

FIG. 2 depicts an example embodiment of a NPU architecture and an example embodiment of a Hybrid Sparsity-V2 architecture according to the subject matter disclosed herein; and

FIG. 3 depicts an electronic device that may include at least one NPU that supports dual-sparsity modes according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The subject matter disclosed herein provides an NPU architecture, generally referred to as a hybrid-sparsity architecture, that supports activation sparsity in a NPU that is also configured for N:M fine-grain structured weight sparsity. The hybrid-sparsity NPU may operate in several sparse modes, such as, structured weight sparsity, random weight sparsity, random activation sparsity, dual sparsity with random activation sparsity and structured weight sparsity, and dual sparsity with random activation sparsity and random weight sparsity.

Two different types of sparse NPU core architectures are disclosed herein. A first type of sparse NPU core architecture supports structured weight sparsity, random weight sparsity, random activation sparsity, dual sparsity with random activation sparsity and structured weight sparsity, and dual sparsity with random activation sparsity and random weight sparsity. A second type of sparse NPU core architecture supports dual sparsity and uses an ANDing technique. A significant benefit provided by the subject matter disclosed herein is that a hybrid sparsity NPU may be efficiently implemented using sparse logic.

While an existing system only supports N:M=2:4 structured weight sparsity, the hybrid-sparsity NPU disclosed herein supports dual sparsity (i.e., activation sparsity and weight sparsity) in which activation sparsity may be random sparsity and weight sparsity may be structured weight sparsity (N:M=1:4, 2:4, 2:8, 4:8) and random weight sparsity.

The “Hybrid Sparsity-V1” architecture may run DNN tasks with various modes, such as: (1) a N:M=2:8 structured weight-sparse mode that provides a 4× speed up and ˜3.5 power/area efficiency improvement (as compared to a dense baseline architecture); (2) a dual sparsity mode with a N:M=2:4 structured sparsity with ˜2.5× power/area efficiency improvement; (3) a dual sparsity mode with random weight sparsity with ˜2.5 power efficiency improvement; (4) a random weight-sparsity mode with ˜3× power efficiency improvement; and (5) a random activation-sparsity mode with ˜1.5 power efficiency improvement.

The Hybrid Sparsity-V1 architecture may be configured to use weight-preprocessing techniques that may be more efficient for DNN inference-type operations. A second embodiment, referred to herein as a Hybrid-V2 architecture, a NPU architecture uses AND-gates that may be more efficient for DNN training-type operations.

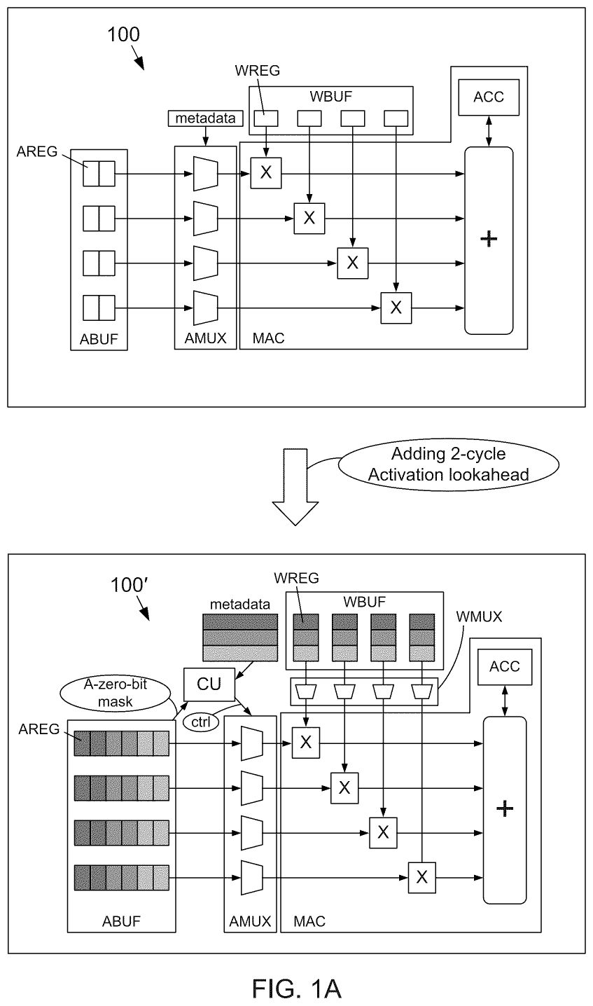

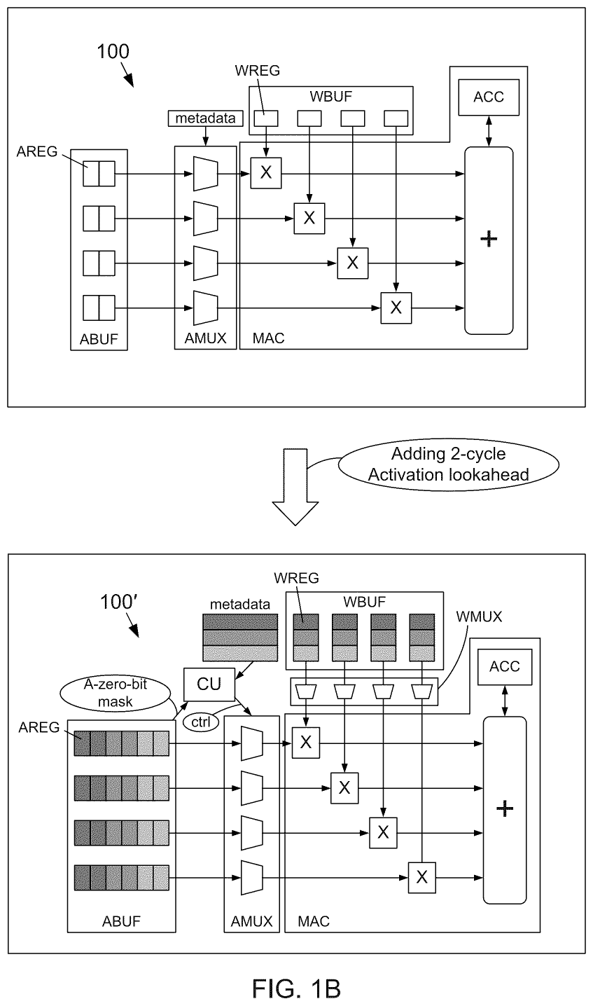

FIG. 1A depicts an example embodiment of a NPU architecture 100 and an example embodiment of a dual-sparsity NPU architecture 100′ according to the subject matter disclosed herein. The NPU architecture 100 is depicted at the top of FIG. 1A and the example embodiment of the dual-sparsity NPU architecture 100′ is depicted at the bottom of FIG. 1A. The example NPU architecture 100 is configured for a 2:4 fine-grain structured weight sparsity and the dual-sparsity NPU architecture 100′ is configured for a 2:4 fine-grain structured weight sparsity that includes a 2-cycle activation lookahead. The dual-sparsity NPU architecture 100′ is referred to herein as a Hybrid Sparsity-V1.

The NPU architecture 100 may include a multiply and accumulate (MAC) unit having an array of four multipliers (each indicated by a block containing an X). The accumulator portion of the MAC unit includes an adder tree (indicated by a block containing a +) and an accumulator ACC. Additionally, the NPU architecture 100 may include a weight buffer WBUF array that contains 1 weight register WREG for each multiplier of the MAC unit, and an activation buffer ABUF that contains a depth of 2 activation registers AREG for each multiplier of the MAC unit. An activation multiplexer AMUX may include an activation multiplexer (indicated by a trapezoidal shape) for each multiplier of the MAC unit. Although not explicitly shown, each activation multiplexer has a fan in of 3. That is, the fan in of each activation multiplexer is connected (not shown) to 3 separate AREGs. In operation, a weight value in a WREG is input to a multiplier as a first input. Weight metadata is used to control the multiplexers of the AMUX to select an appropriate AREG in the ABUF corresponding to each weight value. The activation value in a selected AREG is input to a multiplier as a second input corresponding to first input to the multiplier. The NPU architecture 100 provides a speed up of 2× over a NPU architecture configured only for weight sparsity. Additional details of the NPU architecture 100 are provided in (attorney docket 1535-849), which is incorporated by reference herein.

By adding a 2-cycle random activation lookahead, the NPU architecture 100 may be reconfigured to be the Hybrid Sparsity-V1 architecture 100′, which is configured for dual sparsity that includes a 2:4 fine-grain structured weight sparsity that includes a 2-cycle random activation lookahead. The MAC unit of the Hybrid Sparsity-V1 architecture 100′ is not changed from the NPU architecture 100. The WBUF is reconfigured to include a WREG depth of 3. A weight multiplexer array WMUX is added to select an appropriate weight value stored in the WBUF. The ABUF is also increased in size to provide the 2-cycle random activation lookahead, so that the reconfigured ABUF stores 3 cycles for each multiplier of the MAC unit. The AMUX is reconfigured so that each multiplexer has a fan in of 9. That is, each multiplexer of the AMUX is a 9-to-1 multiplexer. A control unit is also added that in operation receives an activation zero-bit mask (A-zero-bit mask) and weight metadata in order to control (ctrl) the multiplexers of the AMUX to select appropriate AREGs. The example embodiment of the dual-sparsity NPU architecture 100′ provides a speed up of ˜3× over a NPU architecture configured for only weight sparsity.

The Hybrid Sparsity-V1 architecture 100′ may also be used for random weight sparsity operations. FIG. 1B depicts the example embodiment of a NPU architecture 100, and an example embodiment of a dual-sparsity NPU architecture 100′ according to the subject matter disclosed herein. The NPU architecture 100 is depicted at the top of FIG. 1B and the example embodiment of the dual-sparsity NPU architecture 100′ is depicted at the bottom of FIG. 1B. The example NPU architecture 100 is configured for a random weight sparsity of (T_{w}=1,C_{w}=1,Tₐ=0). Configuration details for the NPU architecture 100 are described above in connection with FIG. 1A.

The 2-cycle random activation lookahead reconfiguration described above of the NPU architecture 100 to form the Hybrid Sparsity-V1 architecture 100′ may also be used for random weight sparsity operations that includes a 2-cycle random activation lookahead. By adding the 2-cycle random activation lookahead, the random sparsity mode of the Hybrid Sparsity-V1 architecture provides a random sparsity mode of (T_{w}=1,C_{w}=1,Tₐ=2). Although configured to operate with a different sparsity mode, the dual-sparsity NPU architecture 100′ depicted in FIG. 1B is still referred to as the Hybrid Sparsity-V1. The Hybrid Sparsity-V1 architecture 100′ is the same as described above in connection with FIG. 1A.

For random weight sparsity, the effective activation lookahead the NPU architecture 100′ is 5 cycles based on the 6 AREG depth of the ABUF with a maximum speed up of 6× (typically 2×) over a NPU architecture configured for only weight sparsity. Regarding weight preprocessing of random weight sparsity, if the weight mask is updated infrequently, software-based preprocessing may be used. If the weight mask is updated frequently, then hardware-based preprocessing by adding a weight-preprocessing unit may be a better approach.

Using similar design logic, the Hybrid Sparsity-V1 architecture 100′ may be used to support different sparsity modes. That is, the Hybrid Sparsity-V1 architecture 100′ also supports 1:4 and 4:8 sparsity modes when configured for weight-only structured sparsity based on a 2:8 structured-sparsity mode architecture that is reconfigured for the other modes, such as 1:4, 2:4 and 4:8 structured sparsity modes. Table 1 sets forth some aspects of Hybrid Sparsity-V1 architecture 100′. In Table 1, an “S” means “structured” for structured sparsity, and an “R” means “random” for random sparsity. The top row of Table 1 shows that the Hybrid Sparsity-V1 architecture may be used to support 2:4 structured weight sparsity and random activation sparsity with 2-cycle ahead. The next row down shows that the Hybrid Sparsity-V1 architecture may be used to support 2:4 structured 2:4 weight sparsity alone. If 2:8 structured weight sparsity is desired, then all of the sparse logic may be used on the weight side of the architecture, which provides a 4× speed up. The third row down shows that the Hybrid Sparsity-V1 architecture supports random weight sparsity with 3-cycle activation lookahead and 1-channel weight lookaside, which provides a maximum of a 4× speed up. The fourth row down shows that the Hybrid Sparsity-V1 architecture may be configured for only for activation sparsity by adding 1-channel activation lookaside.

TABLE 1

| | Sparsity | | HW Overhead | | | | |
|---|---|---|---|---|---|---|---|
| Architecture | W-sparse | A-sparse | ABUF | AMUX | WBUF | WMUX | Ctrl |
| Hybrid | S(N:M = 2:4) | R(Tₐ = 2) | 6 | 9 | 3 | 5 | Arbiter |
| | S(N:M = 2:4) | — | | | | | (for A-only) + |
| | R(T_{w} = 3, C_{w} = 1) | — | | | | | CU |
| | — | (Tₐ = 2, Cₐ = 1) | | | | | (for Dual) |

The Hybrid Sparsity-V1 architecture supports four different sparsity modes for a hardware cost per multiplier of a 6-AREG depth in the ABUF, a 9-to-1 AMUX per multiplier, a 3-WREG depth in the WBUF, and a 5-to-1 WMUX. Additionally, the additional hardware includes a controller (arbiter) to arbitrate the activations and a control unit to control both weight and activation movement for dual sparsity.

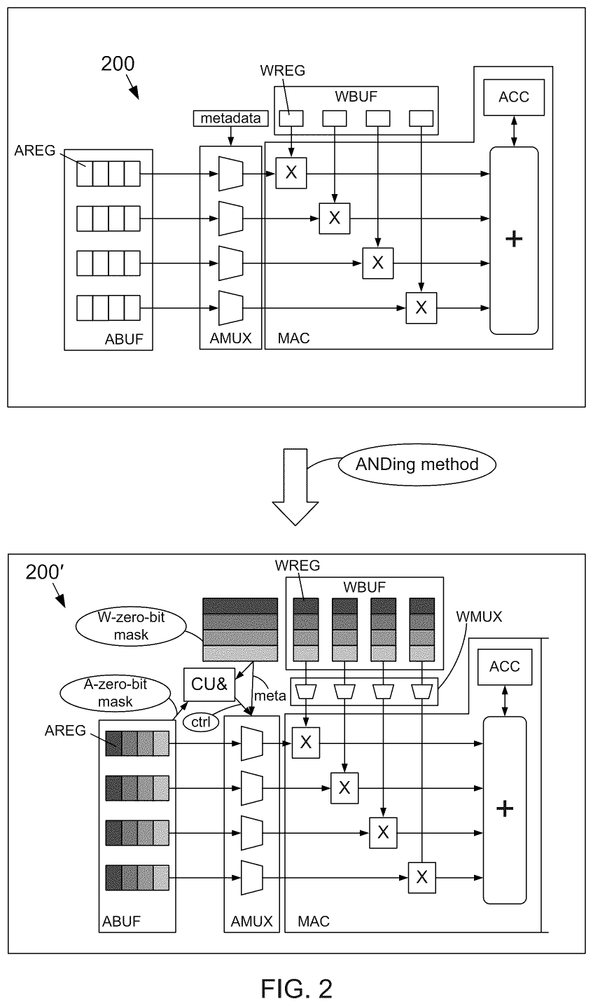

FIG. 2 depicts an example embodiment of a NPU architecture 200 and an example embodiment of a Hybrid Sparsity-V2 architecture 200′ according to the subject matter disclosed herein. The NPU architecture 200 is depicted at the top of FIG. 2 and the example embodiment of the NPU architecture 200′ is depicted at the bottom of FIG. 2. The example NPU architecture 200 is configured for both a 2:8 fine-grain structured and a random weight sparsity (T_{w}=3,C_{w}=1). The dual-sparsity NPU architecture 200′ configured for dual sparsity and uses an ANDing technique. The dual-sparsity NPU architecture 200′ is referred to herein as a Hybrid Sparsity-V2.

The NPU architecture 200 may include a multiply and accumulate (MAC) unit having an array of four multipliers (indicated by a block containing an X). The accumulator portion of the MAC unit includes an adder tree (indicated by a block containing a +) and an accumulator ACC. Additionally, the NPU architecture 200 may include a weight buffer WBUF that contains 1 weight register WREG for each multiplier of the MAC unit, and an activation buffer ABUF that contains a depth of 4 activation registers AREG for each multiplier of the MAC unit. An activation multiplexer AMUX may include an activation multiplexer (indicated by a trapezoidal shape) for each multiplier of the MAC unit. Although not explicitly shown, each activation multiplexer has a fan in of 7. That is, the fan in of each activation multiplexer is connected (not shown) to 7 separate AREGs. In operation, a weight value in a WREG is input to a multiplier as a first input. Weight metadata is used to control the multiplexers of the AMUX to select an appropriate AREG in the ABUF corresponding to each weight value. The activation value in a selected AREG is input to a multiplier as a second input corresponding to first input to the multiplier. Weight metadata is used to control the multiplexers of the AMUX to select an appropriate AREG in the ABUF. The NPU architecture 200 provides a speed up of 4× for a 2:8 fine-grain structured weight sparsity, or a speed up of 2.7× for a random weight sparsity. Additional details of the NPU architecture 200 are provided in (attorney docket 1535-849), which is incorporated by reference herein.

By using an ANDing technique and increasing the size of the WBUF, the example NPU architecture 200 may be reconfigured to form the Hybrid Sparsity-V2 architecture 200,′ which is configured for dual sparsity and provides a speed up of 3×. The MAC unit of the Hybrid Sparsity-V2 architecture 200′ is not changed from the NPU architecture 200. The WBUF is reconfigured to include a WREG depth of 4. The ABUF and the AMUX are not changed from the NPU architecture 200. A control unit (CU) that includes an ANDing (&) functionality is added that may receive an activation zero-bit mask (A-zero-bit mask), a weight zero-bit-mask (W-zero-bit mask) and weight metadata, and ANDs the two bit masks and uses the weight metadata to control (ctrl) the multiplexers of the AMUX to select appropriate AREGs in operation. The example embodiment of the NPU architecture 200′ provides a speed up of ˜3×.

Table 2 sets forth some configuration aspects of Hybrid Sparsity-V2 architecture 200′. In Table 2, an “S” means “structured” for structured sparsity, and an “R” means “random” for random sparsity. Additionally, an “L” associated with the Hybrid Sparsity-V1 indicates a relatively large hardware overhead configuration, and an “S” associated with the Hybrid Sparsity-V1 indicates a relatively small hardware overhead configuration. The different sparsity configurations are indicated below the Hardware heading. The register depths are shown below the ABUF and the WBUF headings, and the multiplexer fan ins are shown below the AMUX and WMUX headings for the different sparsity configurations. The number of adder trees for each sparsity configuration are shown below the ADT heading. The CTRL heading indicates that type of control that is used for a sparsity configuration in which “CU” stands for Control Unit, “Arb” stands for an Arbitrator unit, “Preproc” stands for preprocessing, and “On-the-Fly” stands for on-the-fly processing. Speed up for the different sparsity configurations is shown below the Speed Up heading. The “-/(4)” and the “-/(7) appearing towards the bottom of Table 2 respectively indicate the WBUF and WMUX resources associated with “preprocessing” and “on-the-fly” control modes. A “-” indicates that no WBUF or WMUX resources are needed with the weight tensors are compressed and metadata is generated in compile time. If “on-the-fly” mode is used in which weight tensors are not compressed in compile time and metadata is not generated prior to the runtime, the WBUF uses a fan-in of 4 and WMUX has a depth of 7 registers.

TABLE 2

| Architecture with Sparse | | | | | | | | |
|---|---|---|---|---|---|---|---|---|
| Configuration | | ABUF | AMUX | WBUF | WMUX | ADT | CTRL | Speed Up |
| Hybrid- | Hardware | 9 | 9 | 3 | 5 | 1 | CU + Arb | — |
| V1-L | confAW- | 6 | 9 | 3 | 3 | 1 | CU | ~3x |
| | S(Tₐ = 2, N:M = 2:4) | | | | | | | |
| | confAW- | 9 | 9 | 3 | 3 | 1 | CU | ~3x |
| | R(Tₐ = 2, T_{w} = 2) | | | | | | | |
| | confW- | 4 | 7 | — | — | 1 | Preproc | 4x |
| | S(N:M = 2:8) | | | | | | | |
| | confW- | 4 | 7 | — | — | 1 | Preproc | ~2.7x |
| | R(T_{w} = 3, C_{w} = 1) | | | | | | | |
| | confA(Tₐ = 2, Cₐ = 1) | 3 | 5 | 3 | 5 | 1 | Arb | ~1.7x |
| Hybrid- | Hardware | 6 | 9 | 3 | 5 | 1 | CU + Arb | — |
| V1-S | confAW- | 6 | 9 | 3 | 5 | 1 | CU | ~3x |
| | S(Tₐ = 2, N:M = 2:4) | | | | | | | |
| | confAW- | 6 | 9 | 3 | 5 | 1 | CU | ~2.2x |
| | R(Tₐ = 2, T_{w} = 1,C_{w} = 1) | | | | | | | |
| | confW- | 4 | 7 | — | — | 1 | Preproc | ~4x |
| | S(N:M = 2:8) | | | | | | | |
| | confW- | 4 | 7 | — | — | 1 | Preproc | ~2.7x |
| | R(T_{w} = 3, C_{w} = 1) | | | | | | | |
| | confA | 3 | 5 | 3 | 5 | 1 | Arb | ~1.7x |
| | (Tₐ = 2, Cₐ = 1) | | | | | | | |
| Hybrid- | Hardware | 4 | 7 | 4 | 7 | 1 | CU(&) + Arb | — |
| V2 | confAW&- | 4 | 7 | 4 | 7 | 2 | CU | ~3x |
| | R(d₁ = 3, d₂ = 1) | | | | | | | |
| | confW- | 4 | 7 | — | — | 1 | Preproc | 4x |
| | S(N:M = 2:8) | | | | | | | |
| | confW- | 4 | 7 | —/(4) | —/(7) | 1 | Preproc/ | ~2.7x |
| | R(3, 1, 0) | | | | | | On-the-fly | |
| | confA- | 4 | 7 | 4 | 7 | 1 | Arb | ~1.8x |
| | R(3, 1, 0) | | | | | | | |

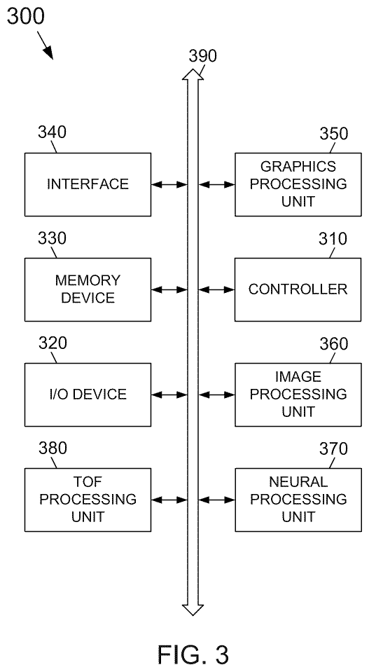

FIG. 3 depicts an electronic device 300 that may include at least one NPU that supports dual-sparsity modes according to the subject matter disclosed herein. Electronic device 300 and the various system components of electronic device 300 may be formed from one or modules. The electronic device 300 may include a controller (or CPU) 310, an input/output device 320 such as, but not limited to, a keypad, a keyboard, a display, a touch-screen display, a 2D image sensor, a 3D image sensor, a memory 330, an interface 340, a GPU 350, an imaging-processing unit 360, a neural processing unit 370, a TOF processing unit 380 that are coupled to each other through a bus 390. In one embodiment, the 2D image sensor and/or the 3D image sensor may be part of the imaging processing unit 360. In another embodiment, the 3D image sensor may be part of the TOF processing unit 380. The controller 310 may include, for example, at least one microprocessor, at least one digital signal processor, at least one microcontroller, or the like. The memory 330 may be configured to store a command code to be used by the controller 310 and/or to store a user data. The neural processing unit 370 may include at least one NPU that supports dual-sparsity modes according to the subject matter disclosed herein.

The interface 340 may be configured to include a wireless interface that is configured to transmit data to or receive data from, for example, a wireless communication network using a RF signal. The wireless interface 340 may include, for example, an antenna. The electronic system 300 also may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service—Time Division Duplex (UMTS-TDD), High Speed Packet Access (HSPA), Evolution Data Optimized (EVDO), Long Term Evolution—Advanced (LTE-Advanced), Multichannel Multipoint Distribution Service (MMDS), Fifth-Generation Wireless (5G), Sixth-Generation Wireless (6G), and so forth.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A neural processing unit, comprising:
a weight buffer configured to store weight values in an arrangement selected from a group comprising a structured weight sparsity arrangement and a random weight sparsity arrangement;
a weight multiplexer array configured to output one or more weight values stored in the weight buffer as first operand values based on the selected weight sparsity arrangement;
an activation buffer configured to store activation values;
an activation multiplexer array comprising inputs to the activation multiplexer array coupled to the activation buffer, the activation multiplexer array configured to output one or more activation values stored in the activation buffer as second operand values, each respective second operand value and a corresponding first operand value forming an operand value pair; and
a multiplier array configured to output a product value for each operand value pair.

2. The neural processing unit of claim 1, wherein the weight multiplexer array is further configured to select the one or more weight values in a lookahead manner, and
wherein the activation multiplexer array is further configured to select the one or more activation values in the lookahead manner.

3. The neural processing unit of claim 2, wherein the weight multiplexer array is further configured to select the one or more weight values in a lookaside manner, and
wherein the activation multiplexer array is further configured to select the one or more activation values in the lookaside manner.

4. The neural processing unit of claim 3, wherein the weight multiplexer array is configured to select the one or more weight values in a lookahead of at least 3 timeslots and in a lookaside of 1 channel, and
wherein the activation multiplexer array is configured to select the one or more activation values in a lookahead of at least 3 time slots and in a lookaside of at least 2 channels.

5. The neural processing unit of claim 1, wherein the weight multiplexer array is further configured to select the one or more weight values in a lookaside manner, and
the activation multiplexer array is further configured to select the one or more activation values in the lookaside manner.

6. The neural processing unit of claim 1, wherein the weight values are stored in the weight buffer in the structured weight sparsity arrangement,
the neural processing unit further comprising a control unit configured to control the activation multiplexer array to select and output one or more activation values stored in the activation buffer based on the structured weight sparsity arrangement.

7. The neural processing unit of claim 1, wherein the weight values are stored in the weight buffer in the random weight sparsity arrangement,
the neural processing unit further comprising a control unit configured to control the activation multiplexer array to select and output one or more activation values stored in the activation buffer based on the random weight sparsity arrangement of the weight values.

8. The neural processing unit of claim 7, wherein the activation values are stored in the activation buffer in a random activation sparsity arrangement, and
wherein the control unit is further configured to control the activation multiplexer array to select and output the one or more activation values based on the random weight sparsity arrangement and on the random activation sparsity arrangement.

9. The neural processing unit of claim 8, wherein the control unit is further configured to select and output the one or more activation values based on an ANDing of an activation zero-bit mask of activation values stored in the activation buffer and a weight zero-bit mask of weight values stored in the weight buffer.

10. The neural processing unit of claim 1, wherein the weight multiplexer array comprises four multiplexers, the activation multiplexer array comprises four second multiplexers and the multiplier array comprises four multipliers.

11. A neural processing unit, comprising:
a weight buffer comprising an array of weight registers, each weight register being configured to store a weight value that is in an arrangement selected from a group comprising a structured weight sparsity arrangement and a random weight sparsity arrangement;
a weight multiplexer configured to select a weight register based the weight sparsity arrangement of the weight values stored in the weight buffer and output the weight value stored in the selected weight register as a first operand value;
an activation buffer comprising an array of activation registers, each activation register being configured to store an activation value;
an activation multiplexer configured to select and output an activation value stored in the activation buffer as a second operand value, the second operand value corresponding to the first operand value and forming a first operand value pair; and
a multiplier unit configured to output a first product value for the first operand value pair.

12. The neural processing unit of claim 11, wherein the weight multiplexer is further configured to select the weight value in a lookahead manner, and
wherein the activation multiplexer is further configured to select the activation value in the lookahead manner.

13. The neural processing unit of claim 12, wherein the weight multiplexer is further configured to select the weight value in a lookaside manner, and
wherein the activation multiplexer is further configured to select the activation value in the lookaside manner.

14. The neural processing unit of claim 11, wherein the weight multiplexer is further configured to select the weight value in a lookaside manner, and
the activation multiplexer is further configured to select the activation value in the lookaside manner.

15. The neural processing unit of claim 11, wherein weight values are stored in the weight buffer in the structured weight sparsity arrangement,
the neural processing unit further comprising a control unit configured to control the activation multiplexer to select and output the activation value based on the structured weight sparsity arrangement.

16. The neural processing unit of claim 11, wherein weight values are stored in the weight buffer in the random weight sparsity arrangement,
the neural processing unit further comprising a control unit configured to control the activation multiplexer to select and output the activation value based on the random weight sparsity arrangement.

17. The neural processing unit of claim 16, wherein activation values are stored in the activation buffer in a random activation sparsity arrangement, and
wherein the control unit is further configured to control the activation multiplexer to select and output the activation value based on the random activation sparsity arrangement.

18. The neural processing unit of claim 17, wherein the control unit is further configured to select and output the one or more activation values based on an ANDing of an activation zero-bit mask of activation values stored in the activation buffer and a weight zero-bit mask of weight values stored in the weight buffer.

19. The neural processing unit of claim 17, wherein the weight multiplexer is part of an array of weight multiplexers, the activation multiplexer is part of an array of activation multiplexers, and the multiplier unit is part of an array of multipliers.

20. The neural processing unit of claim 11, wherein the weight multiplexer is part of an array of weight multiplexers, the activation multiplexer is part of an array of activation multiplexers, and the multiplier unit is part of an array of multipliers.
